(19) United States
(12) Patent Application Publication
(10) Pub. No.: US 2010/0235297 A1
(43) Pub. Date: Sep. 16, 2010

(54) SYSTEM AND METHOD FOR MONITORING FIDUCIARY COMPLIANCE WITH EMPLOYEE RETIREMENT PLAN GOVERNANCE REQUIREMENTS

(75) Inventor: Jeffrey D. Mamorsky, Greenwich, CT (US)

Correspondence Address: GREENBERG TRAURIG, LLP (DC/ORL), 2101 L Street, N.W., Suite 1000, Washington, DC, 20037, US

(73) Assignee: Fiduciary Audit Services Trust, New York, NY (US)

(21) Appl. No.: 12/402,369

(22) Filed: Mar. 11, 2009

(51) Int. Cl. G06Q 40/00

(52) U.S. Cl. 705/36 R

(57) ABSTRACT

An employee retirement plan Fiduciary Audit® questionnaire development, implementation, and reporting system which includes the following interrelated and interdependent web based processes: (1) question and related support development and distribution, (2) organization of questions into questionnaires, (3) assignment of people resources involved, and 4) production and distribution of reports to present findings. The processes occur interactively at three levels: (1) a Master Program level, (2) a Service Provider level, and a (3) Retirement Plan level.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field computing devices for company employee Retirement Plans sponsored by employers and trustees (in the case of multi-employer plans), most popular being pension, 401(k) and 403(b) plans. More particularly, this invention relates to methods and systems designed to reasonably assure those charged with governance that the subject Retirement Plan is being properly monitored for compliance with Internal Control requirements.

### BACKGROUND OF THE INVENTION

Employee Retirement Plans are subject to strict governance requirements and internal control requirements. By American Institute of Certified Public Accountants (“AICPA”) definition, internal control involves: (1) financial reporting, (2) operational efficiency, and (3) legal compliance with existing laws and regulations. In general, different skill sets, disciplines, and professions are required to properly address financial, operational, and legal related issues. These three dimensions of internal control are, however, highly interrelated and interdependent.

Financial reporting, operations, and legal compliance systems of internal control reside at both the Retirement Plan Service Provider operations and the Retirement Plan's Sponsor operations. The Service Provider's internal controls, which affect the many Retirement Plans serviced by them, is subject to an annual AICPA Statement on Auditing Standards (“SAS”) 70 Service Organization's report as performed by the Service Provider's independent CPA and is generally made available to all retirement plans they serve. The retirement plan's level internal Controls are the responsibility of the Retirement Plan Sponsor (i.e. employer or trustees in the case of a multi-employer plan), and are subject to the SAS No. 115 (formerly 112) Communicating Internal Control Related Matters Identified in an Audit as part of the plan's independent CPA audit.

A Retirement Plan Sponsor's in-house retirement plan personnel are called upon to monitor the governance of an employee Retirement Plan including human resource management, payroll, treasury, accounting, legal and labor relations or trustees and in-house pension fund staff in the case of a multi-employer plan. In addition, individuals working for the employer or multi-employer plan charged with governance, having various backgrounds and skills can also be involved. The Retirement Plan Sponsor's professional service providers for a Retirement Plan include some or all of the following: outside legal counsel, independent CPA, actuary and benefit consultant, recordkeeper, trustee, and investment advisor.

It is well known that employee retirement plans are primarily audited by accounting firms who delegate responsibility to recent college accounting graduates with little or no benefits accounting background; moreover, Retirement Plan auditing and accounting is not part of the CPA Exam. The AICPA's Employee Retirement Plan Audit Quality Center provides excellent support, but primarily for the financial reporting dimension of Internal Controls.

As noted in AICPA standard Management Representation Letters, it is the Retirement Plan Sponsor's personnel charged with governance, not the independent CPA, who is responsible for Internal Controls. The independent CPA primarily opines and, by independence rules is, in fact, limited as to their involvement with the design and implementation of Internal Controls. Yet, many Retirement Plan Sponsors do not have up-to-date Retirement Plan-level Internal Controls documented for an independent CPA to review.

The Service Provider is often counted on by the Retirement Plan Sponsor to assist with Internal Controls at the Retirement Plan level, and with related risk protection for those charged with governance, usually the same people who hired the Service Provider, and who received some related instructions when they were hired.

However, Service Providers with hundreds of retirement plans to administer, each involving many in-house and outside people at the retirement plan level have a daunting task to meet such Retirement Plan needs. The Service Provider's systems can only go so far, even a solid SAS 70 handed to a Sponsor for its Retirement Plan's independent CPA is limited to those financial and operational activities that happen at the Service Provider level.

The human resources needed by the Service Provider to assist their clients with Retirement Plan level Internal Controls, required to be monitored at least annually (DOL annual audit requirement), is prohibitive using paper form or relatively static electronic platforms materials, such as questionnaires. What is needed is a software program that enables the Service Provider to cost-effectively assist Sponsor in monitoring the Internal Controls surrounding their Retirement Plans to provide those charged with Retirement Plan governance with reasonable assurance that they are meeting their fiduciary responsibilities. In addition, a software program is needed for Retirement Plan Sponsors to monitor their fiduciary responsibilities in compliance with the Employee Retirement Income Security Act (“ERISA”) and employee benefit requirements of the Internal Revenue Code.

### SUMMARY OF THE INVENTION

In one embodiment, The uniqueness of this web-based invention is its ability to simplify every aspect of compliance with the annual fiduciary responsibilities and legal and accounting obligations universally inherent in the design and operation of employer and trustee-sponsored retirement plans by providing plan sponsors (and their advisors) with a more efficient audit experience through the accuracy and ease of responses via on-screen menus, on-line help (i.e., explanations of terminology, reference material pertinent to each question, chat/e-mail support), immediate editing (ensuring that many forms of inappropriate answers are instantly identified for the user to correct), and flagging (reporting to all appropriate parties of responses representing potential non-compliance and/or opportunity for operational enhancement).

Specifically, the invention's questionnaire, message board, and notification systems will uniquely provide the plan sponsor (and their advisors) with the ability to receive a Fiduciary Audit® Annual Report tailored to specific needs of the plan sponsor such as:
i. a documented identification of any aspect of plan design or administration potentially out of compliance with the requirements of ERISA, the DOL, the IRS, and/or the SEC, requiring further investigation.
   a. notification of appropriate follow-up required from each plan administrator and fiduciary, based on the answers provided by the program's users;
   b. notification to appropriate senior management and specific fiduciaries of their need to view and respond to specific metrics regarding questionnaire completion and review progress;
   c. investigation/resolution of responses with implications on plan effectiveness (operationally and financially), department staffing, client-provider relationships, and legal and fiduciary compliance; and
   d. resolution of responses with implications on the appropriateness of plan rules, the accuracy of the plan's recordkeeping, funding and trust processes, and the support provided by all interrelated systems (e.g., payroll, HRIS, checkwriting, nondiscrimination testing, etc.).
ii. a documented annual update to plan procedural documentation, ordinarily only done at the time of plan design, regulatory, or operational (e.g., service provider) change.
   a. awareness of operational breakdowns and/or regulatory compliance; and
   b. refinement of procedures requiring fiduciary involvement (e.g., hardship withdrawal approval, inbound rollover approval, etc.).
iii. a documented maintenance/enhancement of the plan's investments, their adherence to plan and policy statement requirements, and the fiduciary responsibilities associated with their selection and monitoring.
   a. resolution of responses with implications on the accuracy of plan asset reporting, cash flow and investments, distributions, and related tax reporting;
   b. resolution of responses with implications on the accuracy of plan asset reporting with respect to employer securities, their acquisition and liquidation, and related tax reporting; and
   c. maintenance/enhancement of the plan's investments in coordination with the client's investment committee, their adherence to plan and policy statement requirements, and the fiduciary responsibilities associated with their selection and monitoring.
iv. a documented maintenance/enhancement of legally required and other essential communications to plan participants and eligible employees—for consistency with plan rules, intended operational procedures, and across all mediums of communication (generic print, personalized print, automated voice response system, web site, live customer service, etc.).
v. demonstration of compliance with a new plan audit requirement set forth in SAS No. 115 (formerly No. 112) which provides that there MUST be a process in place designed to provide “reasonable assurance” about “the reliability of financial reporting, effectiveness and efficiency of operations, and compliance with applicable laws and regulations.”

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates one embodiment of a conceptual diagram of an audit questionnaire with a 2 level hierarchical organization.

FIG. 2 illustrates one embodiment of the three tiers of control of audit questionnaire development supported by at least one embodiment of the system and method of the present application.

FIG. 3 illustrates one embodiment of a network capable of supporting at least one embodiment of the system and method of the present application.

FIG. 4 illustrates one embodiment of the modules that comprise the software components of the system and method of the present application.

FIG. 5 illustrates one embodiment of a data structure for audit questions.

FIG. 6 illustrates one embodiment a life cycle for an audit question within an at least one embodiment of system and method of the present application.

FIG. 7 illustrates one embodiment of a question editor user interface.

FIG. 8. illustrates one embodiment of a report selection user interface.

FIGS. 9A and 9B illustrate an exemplary audit report produced for SAS 112 related questions.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

The present invention is, in one embodiment, a Fiduciary Audit® System that provides a system to enable Service Providers to cost-effectively assist Plan Sponsors to monitor internal controls surrounding their retirement plans to provide those charged with retirement plan governance with reasonable assurance that they are meeting their fiduciary responsibilities.

In one embodiment, the invention includes a system and method for cooperative development and completion of interactive, online Fiduciary Audit® questionnaires as well as using the results obtained from the completed Fiduciary Audit® questionnaires to provide reporting on internal controls, such as, for example, annual SAS 70 and SAS 115 reports.

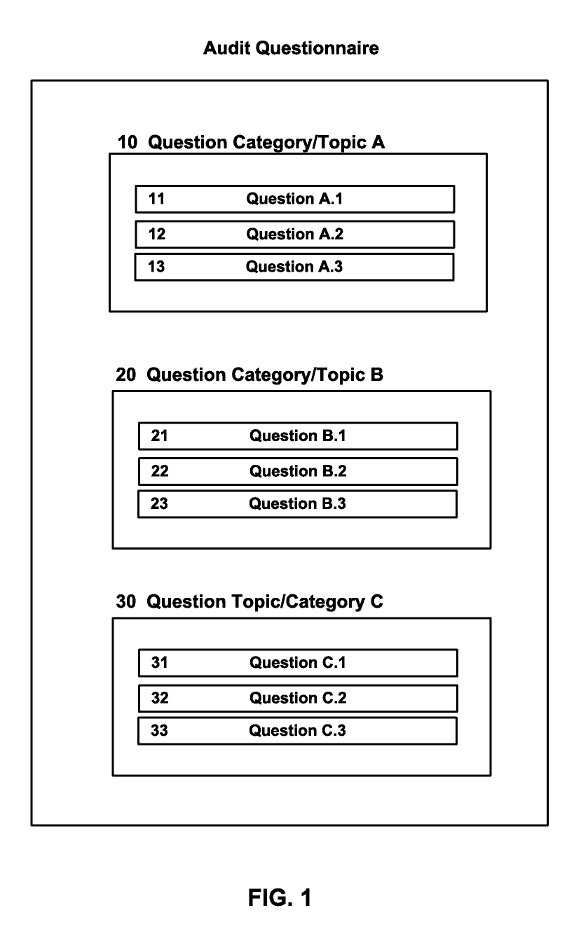

FIG. 1 illustrates one embodiment of a conceptual diagram of a Fiduciary Audit® questionnaire with a 2 level hierarchical organization. The questionnaire can contain one to many question categories or topics 10, 20 and 30. In a retirement plan Fiduciary Audit® questionnaire, the topics could include Employer Information, Plan Document, Participation Data, Eligibility & Participation, Vesting, Service Breaks, Compensation, Employee Contributions, Employer Contributions, Investments, Operating Expenses, Loans, Benefit Payments, Employee Communications, Nondiscrimination Testing, Fiduciary Compliance, and Actuarial Valuation.

In one embodiment, categories or topics can be used to subdivide questions into subject-specific sections tied to aspects of plan design and administration, ordered to generally flow from eligibility and participation to contributions to distributions.

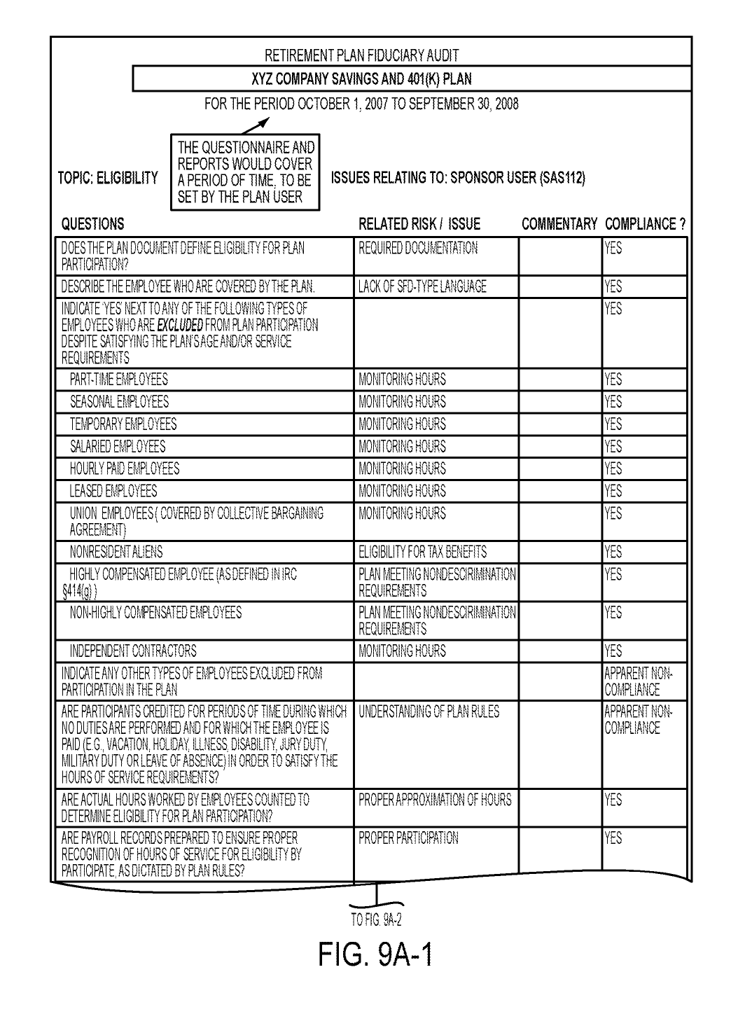

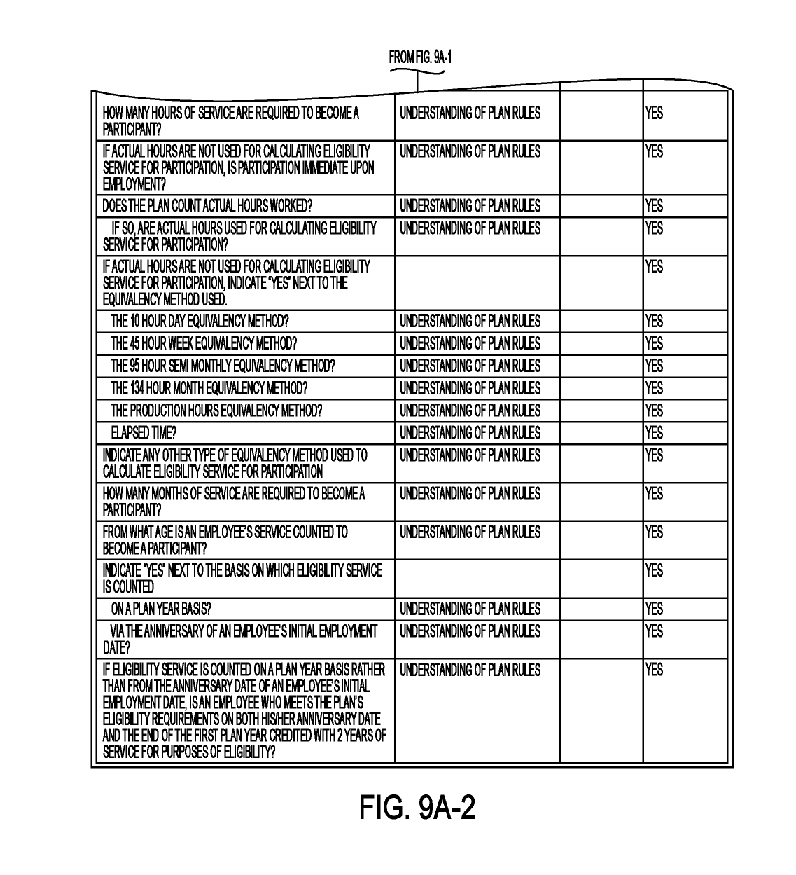

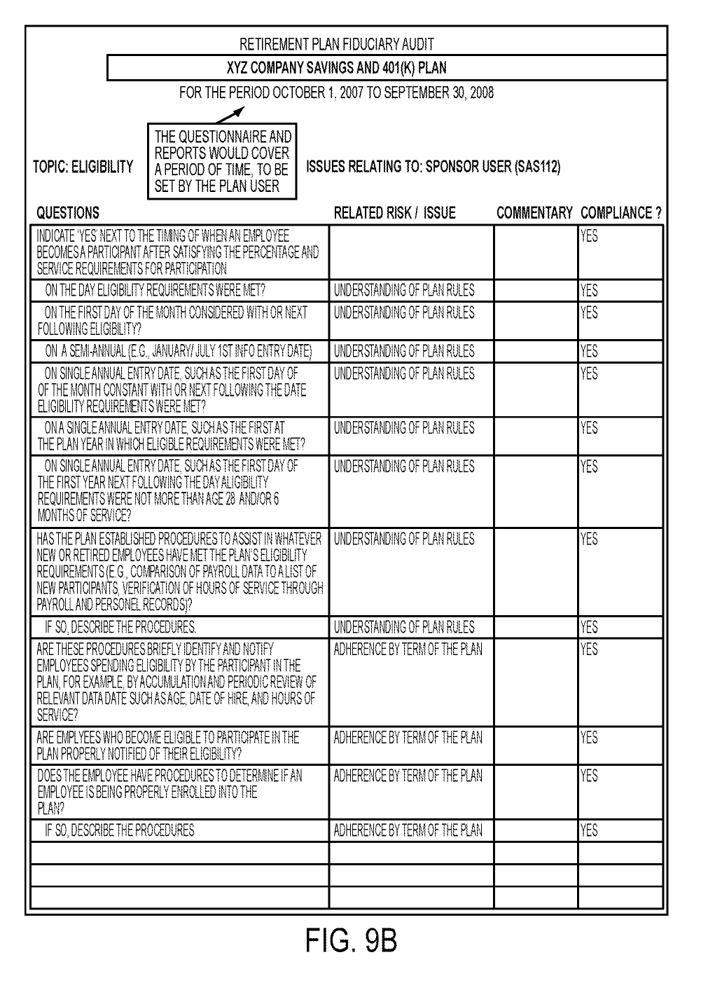

Within each topic/category are one to many detailed audit questions. Such questions can relate to, for example, compliance aspects of a retirement plan. For example, such questions could include:
Are actual hours worked by employees counted to determine eligibility for plan participation?
Are payroll records reviewed to ensure proper recognition of hours of service for eligibility to participate, as dictated by plan rules?
How many hours of service are required to become a participant?
If actual hours are not used for calculating eligibility service for participation, is participation immediate upon employment?
   See also, FIGS. 9A and 9B for illustrative SAS 115 related questions that could be included in an audit questionnaire.

The questionnaire shown in FIG. 1 could be implemented as a hardcopy questionnaire, however, a great many benefits can be derived from implementing the questionnaire as shown in an electronic format that can be interactively developed, implemented and used by a Fiduciary Audit® System as disclosed herein.

The Fiduciary Audit® System as disclosed herein can allow multiple users to develop and maintain electronic questionnaires wherein each user creates and maintains questions relating to areas in which the user has particular expertise. Individual questions within an electronic questionnaire can be quickly modified in a large number of questionnaires, even questionnaires which are currently in process. Question content to be constantly subject to enhancement (i.e., revisions, additions, or deletions), via monitoring of industry trends, regulatory change, trade publications (e.g., AICPA Employee Benefit Plan Audit Guide, Employee Benefit News), and feedback/revisions from providers of a questionnaire.

Individual questions within an electronic questionnaire can provide work flow control parameters such that they are routed to the most qualified person to answer the question and can specify alerts that can be generated if there is a problem with an answer. The completion of questions within an electronic questionnaire can be automatically tracked. In some cases, answers to audit questions can be pre-populated with a previous years answers.

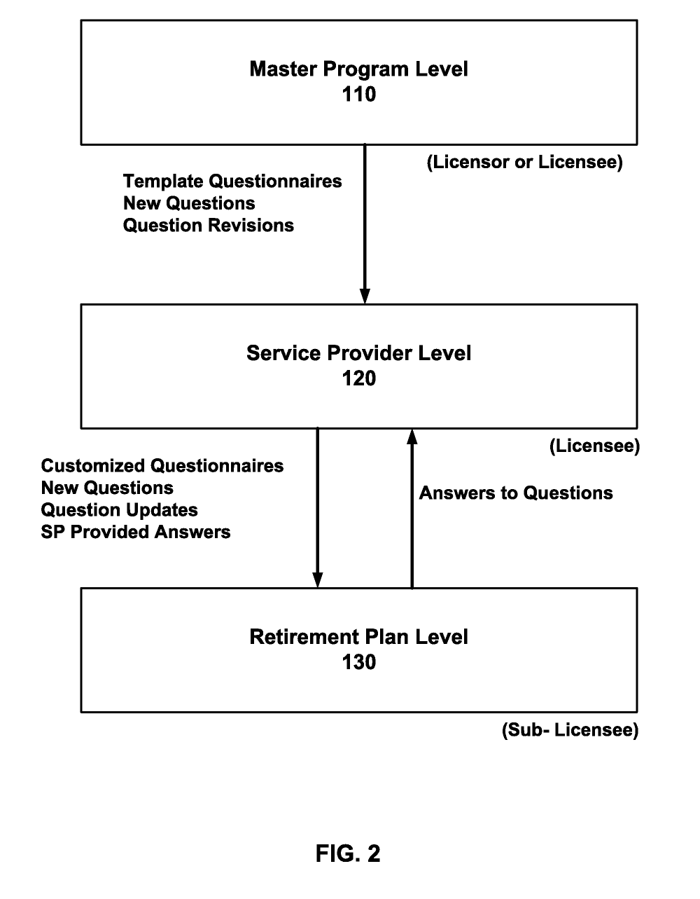

In one embodiment, a Fiduciary Audit® System that provides electronic questionnaires as described above can be implemented with three tiers of control, as illustrated in FIG. 2. The three tiers of control can comprise a Master Program Level 110, a Service Provider Level 120 and a Retirement Plan Level 130.

The Master Program level 110 represents a level where template (e.g. generic) audit questionnaires and questions are developed and maintained by fiduciary compliance experts for use by one or more service providers. In one embodiment, such fiduciary compliance experts could be attorneys employed by a fiduciary governance group of a law firm. In one embodiment, such fiduciary compliance experts could be accountants employed by an accounting firm. In one embodiment, questions developed at the Master Program Level 110 are questions that can be applicable to a broad array of retirement plans and which have not been specifically tailored to a particular retirement plan.

Questionnaire templates can be developed for any type of employee benefit plans subject to audit, including Defined Benefit Plans and Defined Contribution Plans. In one embodiment, audit questions developed at the Master Program level 110 can include question attributes that defines the behavior of questionnaires within the Fiduciary Audit® System. For example, individual questions can be assigned to standard organizational roles.

The Service Provider Level 120 represents a level where template audit questionnaires developed at the Master Control Level 110 are customized into audit questionnaires for auditing retirement plans serviced by a Service Provider. In one embodiment, the questions within an audit questionnaire can be tailored for specific retirement plans. For example, personnel resources of individual Plan Sponsors at the Retirement Plan Level 130 can be tracked at the Service Provider Level 120 and specific questions can be assigned to specific people based on standard organizational roles, and client-specific personnel such that each plan is customized to reasonably ensure optimum responses to all of the questions.

While audit questions will typically be created at the Master Program Level 110, in one embodiment, questions may also be created at the Service Provider Level 120 and added to the questionnaires.

Changes to audit questions made at the Master Control Level flow to organizations in the Service Provider Level 120, and can be accepted or rejected by the organizations in the Service Provider Level. If changes to questions are accepted at the organizations in the Service Provider Level 120, the changes can automatically modify audit questionnaires in use by organizations within the Retirement Plan Level 130.

The Retirement Plan Level 130 represents a level where audit questionnaires developed at the Service Provider Level 120 are used to audit retirement plans. Typically, employees or agents of Plan Sponsors providing such retirement plans answer questions within the audit questionnaires, as described in greater detail below, and generate various audit and compliance reports, as described in greater detail below. In one embodiment, data from completed questionnaires can flow back to a service provider for storage, analysis or to pre-fill the following year's audit questionnaires.

Audit questionnaires can additionally include processing preferences for the questionnaire. For example Plan Sponsor and/or Service Provider preferences can determine if system reports and/or e-mails are populated with details audit alerts for escalation and, where appropriate, corrected response. Plan Sponsor preferences can specify that e-mails are generated by the system to authorized recipients regarding questionnaire completion status relative to deadline for completion.

FIG. 2 further illustrates one embodiment of how the Fiduciary Audit® System could be licensed within the three tiers of control. An organization at the Master Control Level 110 may be the owner of the Fiduciary Audit® System and can license the System to organizations within the Service Provider Level 120. Alternatively, the Fiduciary Audit® System may be owned by a third party service provider and the third party licenses the System to organizations within the Master Control Level and the Service Provider Level 120. Organizations within the Service Provider Level 120 can sub-license the System to organizations within the Retirement Plan Level.

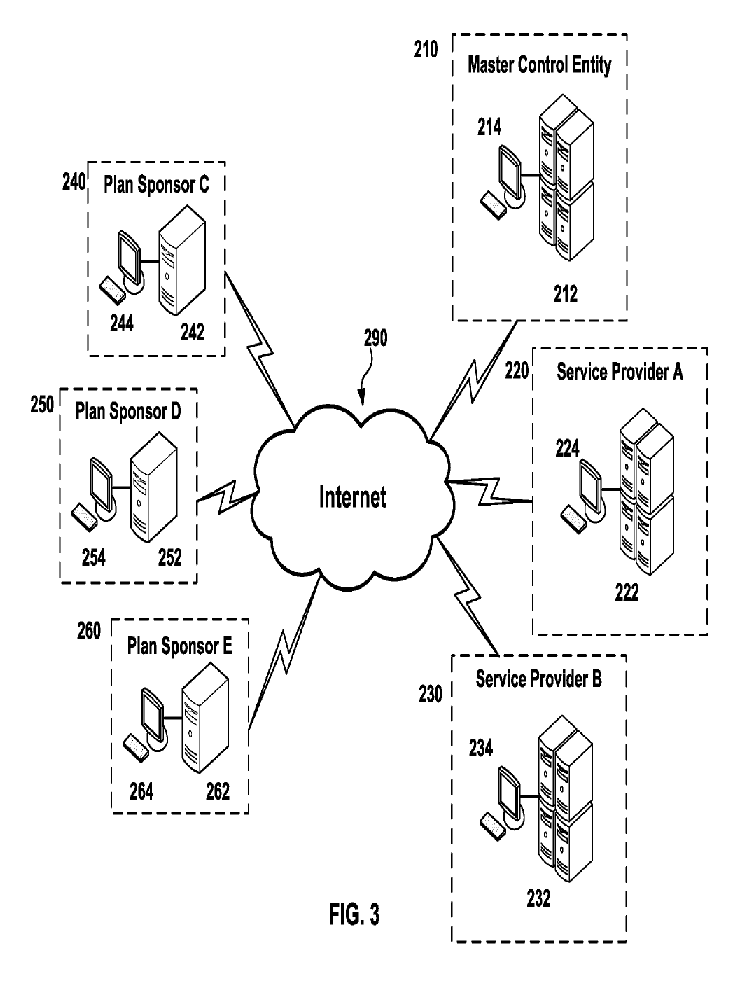

FIG. 3 illustrates one embodiment of a network capable of supporting at least one embodiment of the System and method of the present application.

Master Control Level functions are provided by at least one Master Control Organization 210. Such functions can include, without limitation, audit question and audit question support materials development and audit question distribution functions. Such functions can be implemented using one or more software modules on one or more servers 212 under the control of the Master Control Organization 210. The servers 212 can provide display and input devices 214 that support one or more user interfaces that allow Master level users to develop and maintain audit question and audit question support materials. In one embodiment, the servers 212 are configured to transmit audit question and audit question support materials over a network 290, for example, the Internet, to service providers.

Service Provider Level functions are provided by at least one Service Provider 210 and 220. Such functions can include, without limitation, audit question and audit question support materials development, question distribution functions, and audit questionnaire creation and distribution. Such functions can be implemented using one or more software modules on one or more servers 222 and 232 under the control of the Service Providers 220 and 230. The servers 212 can provide display and input devices 224 and 234 that support one or more user interfaces that allow Service Provider level users to customize, supplement and maintain audit questionnaires, audit questions and audit question support materials provided by a Master Control Organization. In one embodiment, the servers 222 and 232 are configured to transmit audit questionnaires over a network 290, for example, the Internet, to retirement plans.

Retirement Plan Level functions are executed by one or more Plan Sponsor Organizations 240, 250 and 260. Such functions can include, without limitation, responding to audit questionnaires (i.e. answering questions) and producing audit reports. Such functions can be implemented using one or more software modules. In one embodiment, such software modules may reside on a Service Providers server 222 or 232 and Retirement Level functions may be provided via the Internet using a browser based interface that is displayed on display devices 244, 254 and 264 at individual Plan Sponsor Organizations. In one embodiment, when a Service Provider sub-licenses the System to a Plan Sponsor Organization, a unique website (e.g. a unique domain name or unique web page) that provides Fiduciary Audit® functions as described below can be automatically created.

Alternatively, some or all of the retirement plan functions may be provided by software modules hosted on servers 242, 252 and 262 under the control of individual Plan Sponsor Organizations.

Data relating to completed questionnaires, including answers to individual audit questions may be stored and retained by Service Providers 224 and 234 or Plan Sponsor Organizations 240, 250 and 260 on storage devices accessible to such organizations. Data related to completed surveys can be carried over, on a question by question basis from one year to the next and can be used to pre-populate audit questionnaires, in whole or in part.

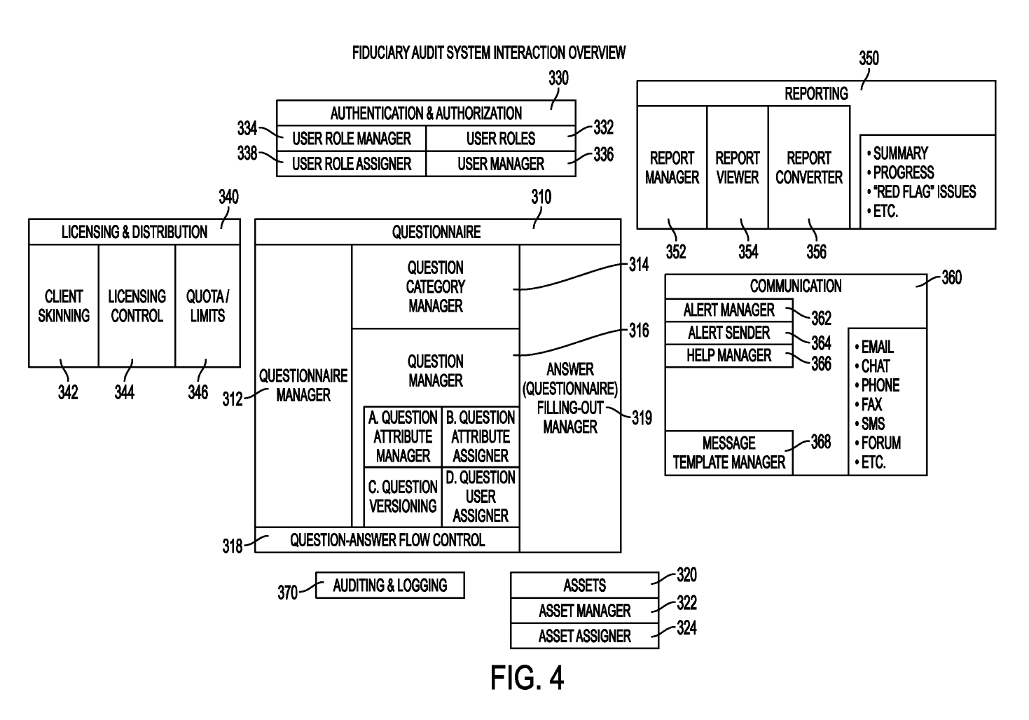

FIG. 4 illustrates one embodiment of the modules that comprise the software components of the system. In the illustrated embodiment, the module comprise a Questionnaire module 310, an Assets module 320, an Authentication and Authorization module 330, a Licensing and Distribution module 340, a Reporting module 350, a Communication module 360 and a Auditing and Logging module 370.

In one embodiment, Questionnaire module 310 comprises a Questionnaire Manager 312, a Question Category Manager 314 a Question Manager 316, a Question-Answer Flow Control Manager 318 and a Questionnaire Fill-Out Manager 319.

The Questionnaire Manager 312 provide facilities to create, update, delete questionnaires. Questionnaires contain, among other things, a collection of question categories or topics. The Question Category Manager 314 provides facilities to create, update, and delete question categories or topics. Question categories can each include among other things, a collection of questions related to the category/topic.

The Question Manager 316 provides facilities to create, update, and delete questions. Questions include, among other things, a collection of assignable attributes, a collection of assignable user roles and/or individual users. User roles and question attributes are discussed in more detail below. See FIG. 4 for one embodiment of a set of question attributes.

The Question Manager 316 comprises a Question Attribute Manager 316a that provides facilities to create, update, and delete question attributes. Question attributes can affect the appearance and behavior of the question, especially, but not limited to, when presented to the end user whose has the responsibility of filling out the answer. The Question Manager 316 further comprises a Question Attribute Assigner 316b that provides facilities to assign attributes to a question. Although most questions will always require specific question attributes be assigned, certain attributes may not be applicable.

The Question Manager 316 further comprises a Question Versioning Control Manager 316c that tracks, via an audit trail (Auditing and Logging 370), any and all changes to questions. Incomplete (not finalized), dependent questionnaires are immediately updated, and affected user(s) informed (via Alert Manager 364) that a change has occurred that requires any previously submitted answer be reviewed and verified.

The Question Manager 316 further comprises a Question User Assigner that provides facilities to assign user roles and/or individual users to a question, or question category. Such a user, or a user within this user role, is responsible for completing the answer to this question, or all answers within this question category.

The Question-Answer Flow Control Manager 318 provides facilities to track the status of all question categories can be affected by the answer to a question. The status of all questions can be affected by the answer to a previous question. The status of all question categories can be affected by the current user role and/or user. The status of all questions can be affected by the current user role and/or user. Most of this question-answer flow control is coordinated through the settings of the question attributes.

The Questionnaire Fill-Out Manager 319 provides facilities to creates and/or updates answers to questions. This function is available to users at all levels (Licensor, Licensee, and Sub-Licensee). This sub-system works in conjunction with the Question-Answer Flow Control Manager 318. All submissions are tracked via an audit trail (Audit and Logging module 319).

In one embodiment, the Assets Module 320 comprises an Asset Manager 322 and an Asset Assigner 324. Assets are a wide range of support resources deemed necessary background information for users to complete their task. These resources can take on the form of references or excerpts from books, articles, publications, web content, electronic documents, URLs, etc.

The Asset Manager 322 provides facilities to create, update, and delete assets and to create, update, and delete asset groups. Asset Groups can contain assets and/or other asset groups.

The Asset Assigner 324 provides facilities to attach an asset or an asset group to a questionnaire, a question category, a question, or a question answer. Assets can be attached to other modules within the system such as Reporting 350, Communication 360, Auditing 370, Licensing 340, and Authentication and Authorization 330 modules.

Assets or asset groups attached at the questionnaire level pertain to the questionnaire as a whole. Assets or asset groups attached at the question category level pertain to this question category as a whole. Assets or asset groups attached at the question level pertain to a specific question. Users who are responsible for providing answers to question scan attach references to, or copies of, supporting documentation.

In one embodiment, the Authentication and Authorization module 330 comprises a User Role Manager 334, a User Manager 336 and a User Role Assigner 338.

User Roles and Permissions 332 are, in one embodiment, stored and maintained by the Authentication and Authorization module 330. Each user role can represent an umbrella of predefined set of system access and task responsibilities that a user is assigned. Individual users must be assigned to at least one, optionally more, user roles.

User Role Manager 334 provides facilities to create, update and deletes user roles and/or permissions. User roles and permissions can be assigned areas of responsibility and access rights within the application, from broad and general, to narrow and specific.

The User Manager 336 provides facilities to create, update, or delete users. Users are individuals (people) at all levels of the Fiduciary Audit® System. In one embodiment, the highest authority user at each of the three levels within the Fiduciary Audit® System is an administrator role responsible for creating extra users and assigning the available roles to these users. The administrator within the top (Master) level is responsible for creating users within its level, as stated, as well as the user who will act as the administrator for a specific licensee. This Master administrator can optionally create any other user within the Licensee Level (e.g. Service Provider Level) as well as assign the user's role.

In one embodiment, the administrator within the middle (Licensee or Service Provider) level does not have access to any controls within the Master Control Level, but is responsible for creating users within its level, as stated, as well as the user who will act as the administrator (if deemed necessary) for a specific Sub-Licensee (e.g. Retirement Plan Level.) This Licensee administrator can optionally create any other user within the Sub-Licensee level, as well as assign their role. The administrator within the lower (Sub-Licensee) level does not have access to any controls within the Licensee or Master level, but is responsible for creating users within its level, as stated, and assigning roles.

The User Role Assignor 338 can provide facilities to assigns a user role and/or an individual user access to a specific module within the system. The User Role Assignor 338 can further provide facilities to assign a user roles and/or an individual user access to a specific question category, allowing for viewing, and possibly, modification of the question category. Rights to view/modify a Question Category encompass rights to view/modify all questions within this question category, and therefore rights to view/modify all question Answers for these questions. All modifications, by any user, are tracked via an audit trail (Auditing and Logging module 370).

The User Role Assignor 338 can further provide facilities to assign a user role and/or an individual user to a specific question, allowing for viewing, and possibly, modification of the question. Rights to view/modify a question encompass rights to view/modify the question answer within this question. All modifications, by any user, are tracked via an audit trail (Auditing and Logging module 370).

The User Role Assignor 338 can further provide facilities to assign a user role and/or an individual user to a specific question answer, allowing for viewing, and possibly, modification of the question answer. All modifications, by any user, are tracked via an audit trail (Auditing and Logging module 370).

In one embodiment, the Licensing and Distribution module 340 comprises a Client Skinning Manager 342, a Licensing Control Manager 344 and a Quota/Limits Manager 346.

Client Skinning Manager 342 provides facilities to creates, update and delete skins for various licensees and sub-licensees. Skins allow for a customization of the appearance of the Fiduciary Audit® System for licensees and sub-licensees. The Master Control Level can create and apply a skin to control the appearance of the application for a licensee. Likewise, the licensee can create and apply a skin to control the appearance of the application for a sub-licensee.

The Licensing Control Manager 344 provides facilities to create, update and delete licenses for various licensees and sub-licensees of the Fiduciary Audit® System. The Quota/Limits Manager 346 provides facilities to creates, update and delete licensing quotas or limits for various licensees and sub-licensees of the Fiduciary Audit® System.

In one embodiment, the Reporting module 350 comprises a Report Manager 352, a Report Viewer 354 and a Report Converter 356.

The Report Manager 352 provides facilities to creates, update, and delete Reports. Reports can be generated for a variety of reasons for any and all of the modules, at all levels of the Fiduciary Audit® System. The Report Viewer 354 displays reports for review by users. In one embodiment, specific report viewing is accessible to users depending on their user role and/or for specified individual users. The Report Viewer 354 can also provide facilities for formatted report printing. The Report Converter 356 provides facilities to convert reports to various file and display formats.

In one embodiment, the Communication module comprises an Alert Manager 362, an Alert Sender 364, a Help Manager 366 and a Message Template Manager 368.

The Alert Manager 362 provides facilities to create, update, and delete alerts. Alerts inform users of various situations that require their immediate attention. Alerts are available at all three levels of the Fiduciary Audit® System, and can be tied to all modules, including, if necessary, the Alert module 360 itself.

The Alert Sender 364 provides facilities to send out alerts to user roles and/or individual users via a specified form of communication. Alerts can be set to trigger based on an action or inaction of a user, at specified intervals, or by some other necessary, yet to be determined cause (e.g. failure to answer a question.) Alerts can be attached to functions within the Questionnaire 310, Licensing 340, Authentication 330, Assets 320, Auditing and Logging 370, Communication 360, and Reporting modules.

The Help Manager 366 provides facilities to create, update, and delete question assistance. In one embodiment, assistance can be provided at the questionnaire, question category, question, or question-answer level. Assistance for questions can be provided to help users in the Licensee and Sub-Licensee complete their tasks. Assistance can be provided by a choice of communication formats and methods (such as: Question-specific Text, Live Chat, Email, FAQ, forum, etc.)

The Message Template Manager 368 provides facilities to create, update, and delete message templates. Message templates allow for “form” messages, where certain words in a message are a variable whose value will be set to meaningful content just before the message is sent out to a User. The Alert Sender 364 can make use of previously created message templates to send alert messages to users.

In one embodiment, the Auditing and Logging module 370 is configured to maintain audit trails. Changes within the various modules of the Fiduciary Audit® System can be documented and archived, in order to provide an audit trail. Individual audit trails can exist for any module or function. In one embodiment, auditing includes, at minimum, the action performed, the old value, the new value, the user performing the change, the date, and the time of the change. Specific user roles and/or individual users can be assigned responsibility for overseeing these various audit trails to ensure compliance.

In one embodiment, the Auditing and Logging module 370 can be further configured to maintain system logs. System logs can be used to track functional errors and potential functional errors within various parts of the Fiduciary Audit® System for review to ensure that the overall Fiduciary Audit® System and its modules are functioning properly.

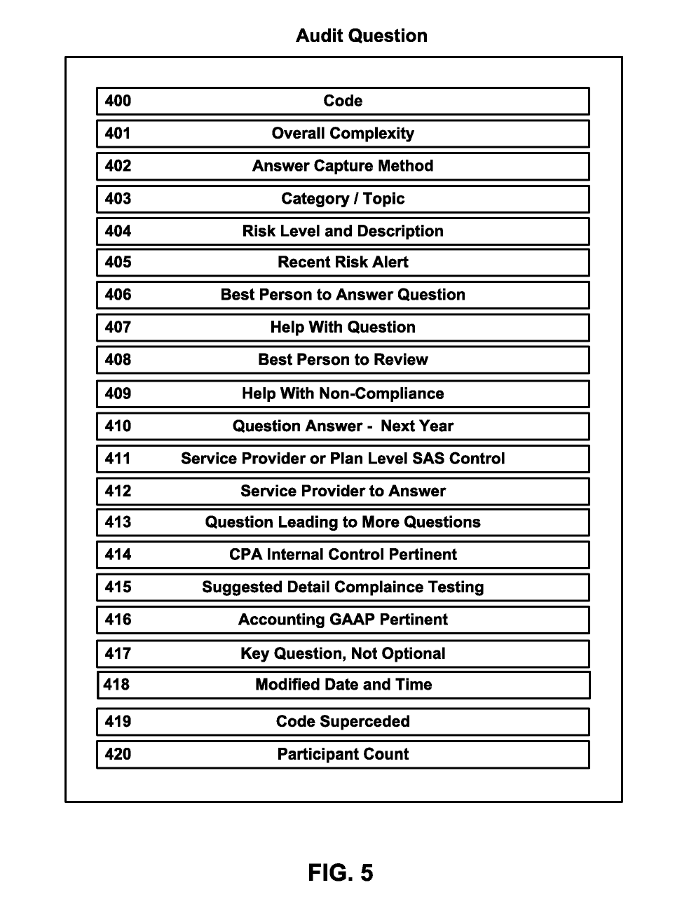

Many functions in various embodiments of the Fiduciary Audit® System can be controlled by question attributes. FIG. 5 illustrates one embodiment of a data structure for audit questions which may be stored on one or more databases located on one or more storage devices accessible to Master Control servers, Service Provider servers or Plan Sponsor servers. Each question comprises a plurality of attributes, wherein each question attribute is stored in one or more data fields. Each data field may comprise one or more subfields, and may be in any format suitable to reflect the information present in the field. Audit questions as they are stored in an audit question database may comprise all, or some of the data fields shown, and may additionally include fields not shown.

The audit question can include a Code field 400 that serves as a unique identifier for questions. The value of the Code field may take any format suitable for uniquely identifying a question. For example, a Code field could be organized to include a questionnaire ID, a topic/category ID and a question number. In an alternative embodiment, a Code field could simply be a sequential number that is automatically generated by the system.

The audit question can comprise an Overall Complexity field 401 that defines the level of complexity of the question. A simple question may be, for example, a Tax ID, whereas a complex question may be a question regarding ongoing actuarial test compliance.

The audit question can comprise an Answer Capture Method field 402 that can be used to specify how an answer to the question to be captured. Each question can to be configured to present various user interface elements such as, for example, radio buttons and/or text boxes, as appropriate (i.e., yes/no, multiple choice with single possible answer, multiple choice with multiple possible answers, date fields, stand-alone text boxes, text boxes appearing upon clicks on certain radio buttons, etc.) Answers can be additionally edited for reasonableness (i.e., alpha vs. numeric, 100% maximum, applicability to type of plan, spell checking, etc.).

The audit question can comprise a Category/Topic field 403 that can be used to subdivide questions into subject-specific sections tied to aspects of retirement plan design and administration, and can be further ordered to generally flow from eligibility and participation to contributions to distributions. Topics can be used to control the placement of questions (i.e., by section and their specific order), as well as the conditions under which the question can appear (e.g., based upon the user's selection of accounting vs. fiduciary governance/legal audit, based upon the user's responses to specific preceding questions, etc.).

Such topics may include, for example, Employer Information, Plan Document, Participation Data, Eligibility & Participation, Vesting, Service Breaks, Compensation, Employee Contributions, Employer Contributions, Investments, Operating Expenses, Loans, Benefit Payments, Employee Communications, Nondiscrimination Testing, Fiduciary Compliance, and Actuarial Valuation.

The audit question can comprise a Risk Level and Description field 404 that defines the associated fiduciary/internal control related risk of a question. For example, AICPA defines “Inherent Risk” in terms of Low, Moderate & High codes and provides a full narrative description of the implications of non-compliance.

The audit question can comprise a Recent Risk Alerts field 405 that can indicate if recent development in the benefit world called for questions to be modified, added, or highlighted to ensure that the Plan is properly addressing emerging insures. Sources for such information may include AICPA Annual Audit Alerts, DOL Audit guide material, WSJ Articles, etc.

The audit question can comprise a Best Person to Answer field 406 that defines who is the best person at a Service Provider or Plan Sponsor organization to answer the question. In one embodiment, the best person can be an individual user. In one embodiment, the best person can be a role (e.g. payroll supervisor.) In one embodiment, the selected person can initially be based on a typical organization structure with “lowest level of competency” suggestions, and can be customized at a later time. The audit question can comprise a Help with Question field 407 that can provide additional information or assets (e.g. documents, media clips and so on) that provides information that can be useful in aiding a user to answer a question. In one embodiment, help can be provided via a pop-up on a user interface.

The audit question can comprise a Best Person to Review field 408 that defines who is the best person at a Service Provider or Plan Sponsor organization to review an answer to the question. In one embodiment, the best person can be an individual user. In one embodiment, the best person can be a role (e.g. payroll supervisor.) In one embodiment, the Best Person to Review field could provide multiple potential respondents and also indicate a recommended sequence of respondents (e.g., record keeper prior to benefits director.)

The audit question can comprise a Help with Non-Compliance field 409 that defines what actions should be taken if the answer to a question might be indicative of a non-compliance issue? In one embodiment, a user can be required to complete a logical “Apparent Weakness” write-up in a PwC style.

The audit question can comprise a Question Answer—Next Year field 410 that defines if and how should the answer be rolled forward to the following year's audit questionnaire. For example, an answer may be a clean lift such as tax ID and name, or may require a fresh answer with prior year's answer displayed as a guide. This can represent a significant time savings for the Plan Sponsor.

The audit question can comprise a Service Provider or Plan Level SAS Control field 411 that defines if a question relates to a SAS 115 (supersedes 112) Plan level operation internal control, an SAS 70 Service Provider level operation internal control, or both. If the question relates to SAS 70, the related pertinent information from that report can be provided on the questionnaire and in the appropriate Topic section. For example, are plan investment holdings and participant accounts properly reconciled on a regular basis.

The audit question can comprise a Service Provider to Answer field 412 that defines whether the answer to the question is to be completed by a Service Provider in advance of a Plan Sponsor user signing on and viewing the questionnaire. This can represent a significant time savings for the Plan Sponsor.

The audit question can comprise a Question Leading to More Questions field 413 that defines if one or more answers to a question cause other follow-up questions to be applicable or not applicable. The follow-up questions appear or do not appear in the questionnaire dynamically based on the answer to the question.

The audit question can comprise a CPA Internal Control Pertinent field 414 that defines if the question is suitable for inclusion in a Questionnaire with answers that the Plan's CPA would find valuable in conducting the annual independent audit. In one embodiment, such questions can be identified by referring to the latest AICPA Benefit Plan audit guides and similar information.

The audit question can comprise a Suggested Detailed Compliance Testing field 415 that defines what procedures should be performed to find if Plan is in compliance. For example, suggested audit type procedures can be developed as applicable to each question.

The audit question can comprise Accounting GAAP Pertinent field 416 that defines if the answer to the question provides (or expected to provide) Generally Accepted Accounting Principle information. Such information can be valuable in preparing the Plans' annual GAAP financial statements as required by the DOL.

The audit question can comprise a Key Question, Not Optional field 417 that defines if the question is considered “key” such that it would be required to be included in Questionnaires developed by a Service Provider. Questions marked as “key” would need an additional step, such as review clearance by a Master Control Organization, to remove from a questionnaire.

The audit question can comprise a Modified Date and Time field 418 that defines when the question was added or modified. Modified Date and Time field 418 could be used to alert users to new questions, indicative of new concerns.

The audit question can comprise a Code Superseded field 419 that defines if the question replaced another question with a different Code value. In one embodiment, superseded questions can be archived.

The audit question can comprise a field Participant Count 420 that defines approximately how many participants or how much dollar volume is subject to the question. Such information can be useful to give an idea of how pervasive the subject matter of the question can be, or if it applies at all.

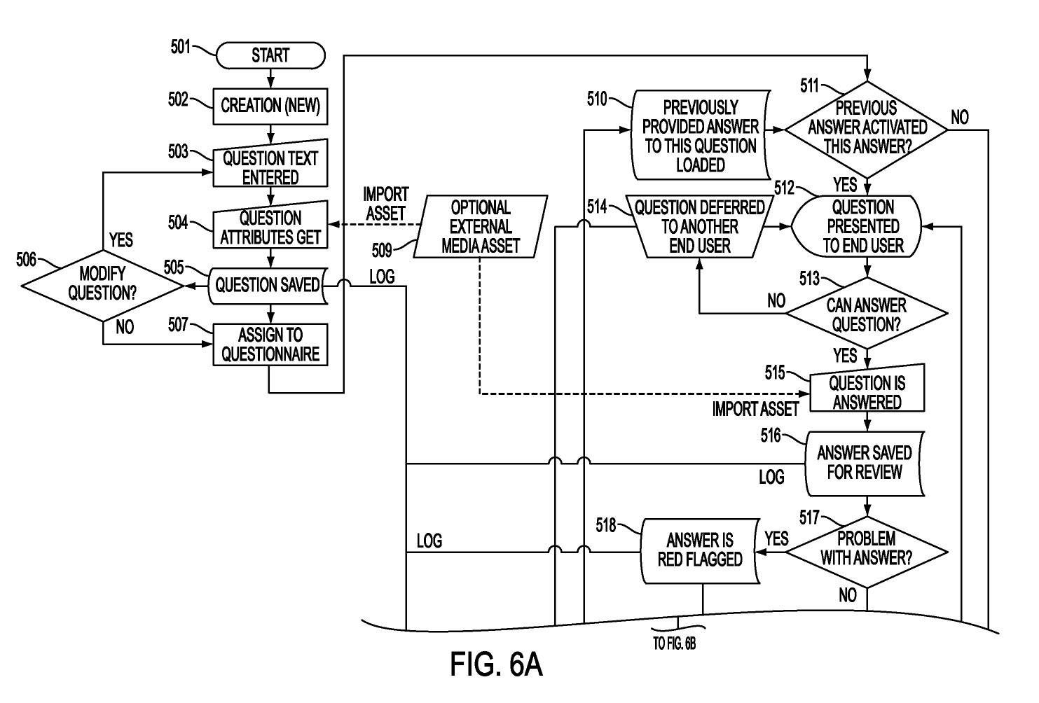

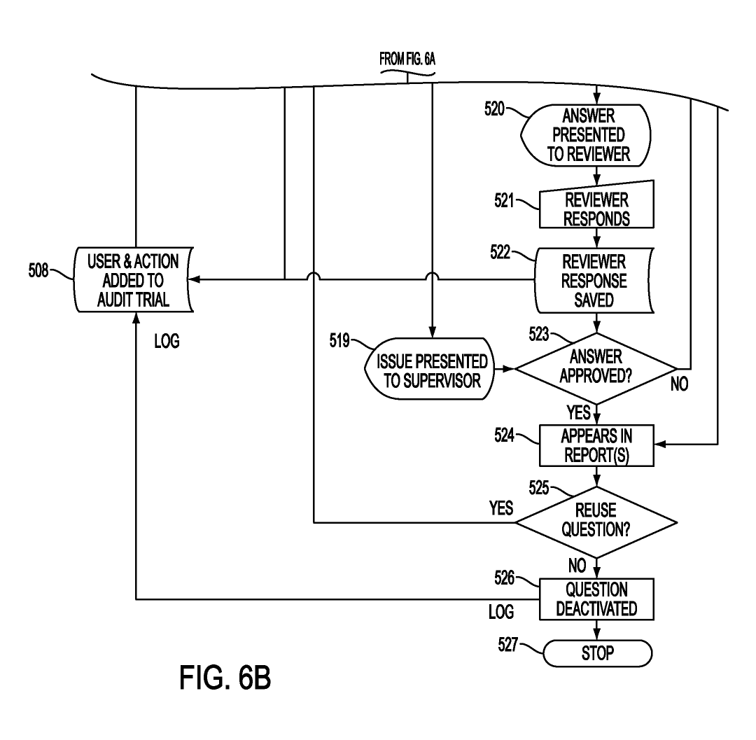

FIG. 6 illustrates one embodiment a life cycle for an audit question within an at least one embodiment of Fiduciary Audit System described in this application.

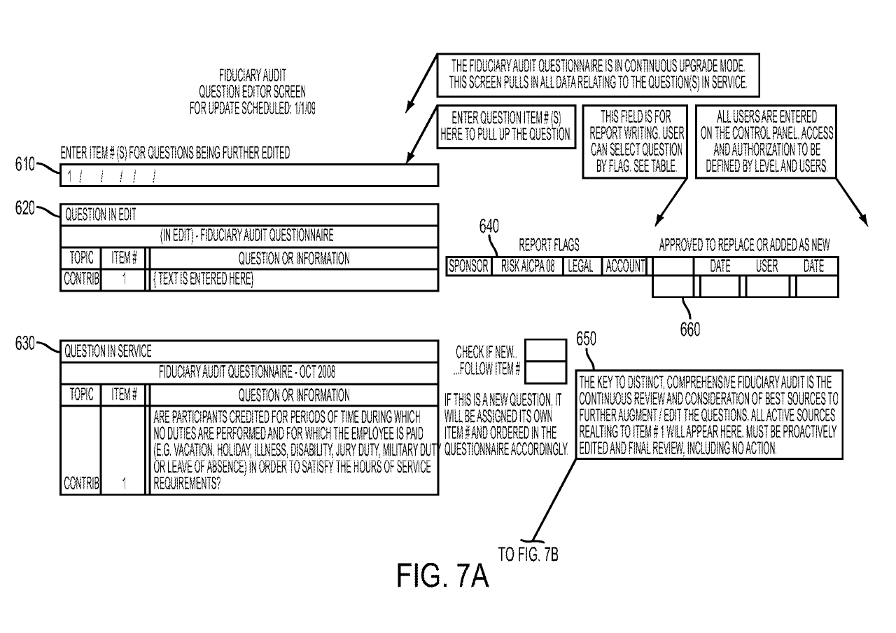

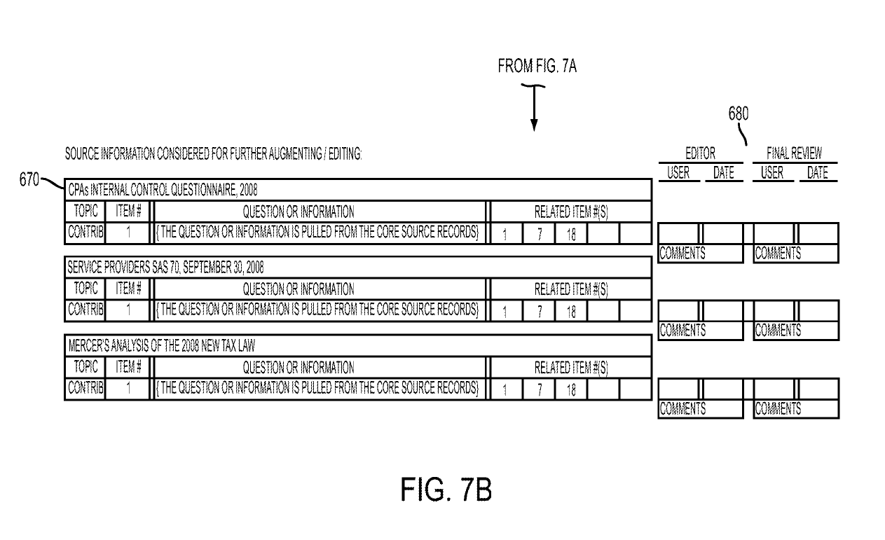

In one embodiment, a question life cycle is started 501 when a Master level user logs in and initiates a question creation function provided by a Question Manager module. One embodiment of a user interface provided by a Question Manager module is illustrated in FIG. 7. A user can enter in one or more question numbers 610 which the user wishes to edit. No question number need be provided if the question is new. The interface provides an entry area 620 where question categories and text can be modified. The interface displays the question currently in service 630 immediately below the question entry area 610.

The interface can further provide an area 640 to set or modify reporting flags. If a question is a new question, the item number the question should follow can be entered 650. In one embodiment, the interface can display information from one or more information sources 670 that question writers can or should consider when modifying questions. Such sources comprise, inter alia, authoritative Retirement Plan industry literature.

When a question is created or modified, or new sources for question content is added to a question, the question writer and at least one question editor must sign-off 660 or 680 on the source modification or question. In one embodiment, question creation security is set primarily at the writer and editor approval sign off. In one embodiment, the users creating, modifying, or editing the question are authenticated before the question can be assigned to a questionnaire 507. Log-in procedures can have established limits on user name/password attempts, with corresponding “forgot password” and “forgot username” e-mailing capabilities based on authorized users established by a system administrator.

A similar function can be provided at Service Provider Level to Service Provider users. In one embodiment, Service Provider users can enter question text and can set a limited number of question attributes. In one embodiment, question attributes are determined at the Master Control level and cannot be modified. In one embodiment question attributes can be entered or changed for a question, as judged by the Questionnaire Manager component of the present system and method.

In one embodiment, Retirement Plan level users cannot create new questions and do not participate in the process illustrated in FIG. 6 until step 507 where questions are assigned to questionnaires, as discussed in more detail below. Note that in all steps shown in FIG. 6 the Master Control Level, Service Provider Level, and Retirement Plan Level, in general, operate autonomously, with information exchanged where, primarily, information flows downward.

The next step in the illustrated question lifecycle in FIG. 6 is creation of a question 502. At the Master Control level, new questions can be created by way of continuous tracking of Retirement Plan industry literature, which can range from text books with over 1,000 pages to short news articles deemed pertinent by the Questionnaire Manager. In one embodiment, tracking the textbook would entail entering a bibliography in the system and then writer examination and editor review approval, both signing off by book chapter. See, e.g., FIG. 7, 680.

Tracking articles, smaller publications, and excerpts from books can be done by scanning in and converting to text that can be sectioned to correspond to specific Question Category Managers' responsibilities, with similar writer and editor sign-offs. See, e.g., FIG. 7, 680. In other words, the literature can be comprehensively tracked and appropriately entered with an authentication trail back to its sources and approval.

In one embodiment, Service Provider level users can be given the same authorities given to Master Control users. In one embodiment, Service Provider level users can be given limited authority to modify question attributes (e.g. step 504 below) This would enable a Service Provider to modify questions for specific topics (e.g., Investments) to meet needs, or bring to light matters beyond the typical accounting, operations, and legal compliance issues as identified at the Master level by the Questionnaire Manager.

In one embodiment, in addition to being able to add/delete/modify questions, the Service Provider can have the ability to import information about their clients' plans directly into the system—e.g., indicative information about multiple plans otherwise requiring repetitive entries by the eventual users of the System (e.g. Question to be answered by Service Provider, FIG. 4, 412.)

The questions made available to the Service Provider Level by the Master Control Level and questions created at the Service Provider Level, can be assigned distinguishing codes so as to be able to track back to the source. Question attributes can include cautions as to responsibilities, particularly if a Key Control question from the Master is being replaced.

The next step in the illustrated question lifecycle is entry of question text 403. In one embodiment, the question creation function interface (see e.g., FIG. 7, 610) has a field to modify questions, or if necessary, replace questions. In one embodiment, questions can be modified (see step 506 below) by dating, allowing the question to continue in use with, for example, wording refinement only. In one embodiment, question attributes and previous answers can remain the same if deemed appropriate by the Questionnaire Manager.

If a new question is created to replace an existing active question, the replaced question's code can be entered by either a Master or Service Provider, and the old question would be designated inactive (remain on file for reference, but not actively in use.) Inactive questions can be reinstated to active status, if/when determined necessary by the Questionnaire Manager. Question attributes can then be set or modified 504. In one embodiment, question fields (see e.g. FIG. 4) are fully editable at the Master level, and can be editable on a selective basis at the Service Provider level.

After a question has been created or modified, the question is then saved 505. In one embodiment questions can be saved “complete” in an authentication process where a question writer and a question editor sign off on the question, or can be saved as “in-progress” and not yet available to assign to a questionnaire. See e.g. FIG. 7. In one embodiment, where a question modification 506 is in progress, a question attribute field for modification initiation date can be set. In one embodiment, when modifying a question, the System can create a copy of the original question, then proceed with creation of a new question 502. The modification date would serve to render the modified question as inactive, and the new question as active.

In one embodiment, questions can be maintained at the Master Control Level, Service Provider Level, and the Retirement Plan Levels. At the Retirement Plan Level, the saved modified questions can be connected to the questionnaire to which the source question was connected. If a modified question is connected to a questionnaire under development (e.g., opened but without final sign-off, usually covering a year of Retirement Plan operations), in one embodiment, the question would flow from the Master level to the Service Provider level when the authentication occurs.

At the Retirement Plan level, the Fiduciary Audit® System can show the question as ready to be modified. In one embodiment, the user can either allow the replacement or choose to stay with the original unmodified question In some cases, an answer to a question (see, e.g. 515) may need to be modified. For subsequent newly-started audits, the new, modified question would flow in automatically.

As discussed above, if a question is modified (e.g. yes in step 506), the question can be modified, in one embodiment, by copying questions being edited, revising as needed, then the system retains the previous version (as inactive) and uses the most recently updated version by virtue of its active status.

In one embodiment, the Retirement Plan Fiduciary Audit® System in progress only accepts modified questions optionally, at the user's discretion after notification to the user of the availability of an updated question (being specific as to which questions are available for update, and allowing question-by-question acceptance/denial of the update). New audits subsequent to the creation of the revised questions automatically use the revised questions.

New or modified questions are then assigned to a questionnaire 507. In one embodiment, questions are attached to a questionnaire structure to be used by the Retirement Plan's Company Sponsor to conduct their Fiduciary Audit® Operational Compliance Review. In one embodiment, the Master Control Level provides two main questionnaire templates: (i) a Defined Contribution template, and (ii) a Defined Benefit template, which are currently the two most common types of Retirement Plans. In one embodiment, Service Providers are given the option to modify questionnaires under this process to create questionnaires customized for specific retirement plans. The one embodiment questions within questionnaires are arranged by the one or more question attribute data fields such as code or topic.

In one embodiment, newly created, unique questionnaires can be saved as templates for reuse for other plans and/or in subsequent years or for copying and modification to create new variations. Such plans can be saved at the Master Control Level or the Service Provider Level and can be modified at any time.

The questions on a questionnaire appear, or are hidden, on the plan's questionnaire questions are answered (e.g. step 515 described below) based on how related questions are answered, as controlled by the question attributes (see, e.g. FIG. 4, 413 Question Leading to More Questions). For example, certain series of questions would appear, others would be hidden, when the radio button for “Cash Balance Plan” is clicked to answer “What type of plan is this?”. In another example, if a plan has no loan provision, the clicked radio button “No” to the question “Does the plan offer loans?” causes a series of loan-related question to be suppressed from that plan's questionnaire.

In one embodiment, if a Key Control question, as identified in the question's attributes (see, e.g. FIG. 4, 417), is not included in the final questionnaire used by the plan, the user creating the questionnaire is alerted or, as an alternative, the question is not allowed to be omitted. For purposes of grouping of responses in reports (e.g. step 524 described below) questions can be labeled as being mandated by SAS 115 (i.e., Retirement Plan internal controls related) or by SAS 70 (i.e., Service Provider internal control related), or both.

When a question is saved, the user creating or modifying the question and the user's action is added to an audit trail 508. History of revisions to specific questions can be retained by the system for ongoing reference. Such history can additionally include commentary on reason(s) for change(s) retained alongside outdated, deactivated questions.

Optional assets may be added to questions 509. For appropriate questions, the user can be given the option of attaching external documents/files in support of their answer. For example, plan documents, Summary Plan Descriptions, formal nondiscrimination testing reports, IRS Private Letter Rulings, etc.

If a previously provided answer to a new or modified question exists, the answer can be loaded 510. In one embodiment, whether an answer is loaded is determined by the question's attributes for carrying forward the prior year's answer to the same question for the same plan. Also, the carry forward will be handled a variety of ways, depending on the user's answer to the re-use of prior year information—from displaying the prior year's answer in grayed-out format while prompting the user yes/no on its use (if yes, no change, if no, un-grey the answer for revision) to automatically requiring new entry, to simply entering the prior year answer. In one embodiment, in all cases, even upon re-use of prior years' answers, each question must receive at least one affirmative response, even if just to indicate that the prior year's answer remains valid.

As described above question attributes can include whether specific answers to previous questions in this questionnaire activate other questions that would not otherwise be asked—for example, when type of plan is entered “Defined Benefit”, questions specific to actuarial services are then included in the questionnaire (otherwise irrelevant for defined contribution plans). Similarly, certain questions can be suppressed depending upon previous answers—for example, many questions about employee and employer contributions, in-service withdrawals, loans, etc. are rendered moot when the type of plan is entered as “Defined Benefit”. If a modified question is suppressed 511, it appears in reports (e.g. step 524 described below), but is not processed further. In one embodiment, the system can automate the numbering of questions and cross-references to other questions as they appear to the user, which can vary based on the addition/suppression of questions.

If the question is not suppressed, it is presented to an end user at the retirement plan level 512. In one embodiment, the person to which the question is presented is determined by a “Best Person to Answer” question attribute (see, e,g, FIG. 4, 406). The “Best Person to Answer” question attribute can specify a role or can specify a specific individual. In one embodiment, template questionnaires can provide a default “Best Person to Answer” by defining the most common selection of corporate personnel/skill set or outside service provider to respond to that category of questions (e.g., payroll management for compensation and contribution-related questions, CFO for investment monitoring questions, etc.)

In one embodiment, the corporate personnel/skill sets surrounding the plan can be provided in a data file by the Master Control Level. The assigned respondent can also be an outside service provider. In one embodiment, users at the Service Provider Level can modify the “Best Person to Answer” to another role or a specific person.

In one embodiment, the user can either be allowed to see and/or respond to the entire questionnaire (perhaps grayed out, signifying read-only access), or can only be allowed to see the questions they are authorized to respond to. Specific users can be assigned the right to view a system-generated report of which questions are assigned to which users/reviewers. Once all questions appropriate for this plan's questionnaire have been identified, the questions for that plan are numbered by the system for the user's reference, and all cross-references to other question numbers by the system's instructions and/or other questions are similarly filled to properly alert the user.

When a question is provided to an end user, the user can choose to answer the question, as described below, or decline to answer the question 513. In one embodiment, unanswered questions can be displayed with blank answers for reporting purposes (see e.g. step 524, described below.)

If a user declines to answer a question, the question can be deferred to another user 514, by, for example, emailing the question to another user, changing the assignment of the question to another user, and so forth. Help attributes in the question's attribute set could alert the user where to seek help. For example, a question could have a prime, likely assignment, then a back up or alternative assignment. For example, the corporate treasurer could be assigned oversight for an Investments Category question.

If the user does not defer the question to another user, the user answers the question 515. In one embodiment, the answer is edited for appropriateness, in addition to editing for plan/legal compliance. For example, the question may be presented with radio buttons programmed to prevent multiple answers when not permitted. Numerics and percentages can be edited to fit within prescribed ranges (e.g. in accordance with editing parameters within question attributes), text may be edited where practical (e.g., spell check, etc.) In one embodiment, an answer can be entered by a user with an indication that the information was received from another user known to the System.

In one embodiment, an answer user interface can be provided where an information box is displayed when the user scrolls over each question (or similar help text can be made available via Help link specific to that question), with question-specific content providing, for example, relevant Internal Revenue Code or ERISA sections and/or administrative considerations, DOL notices, appropriate articles and white papers, etc.

In one embodiment, help for a question may also be provided through an e-mail “chat” feature available to users at each question, with automatic insert into the system-started e-mail message of the user's name, company, and plan, the text of the question, the user's attempted response, and their description of their concern. In one embodiment, the user then receives an automated reply acknowledging receipt of question and providing approximation of response time.

The absence of valid answers to questions can be tracked at the Service Provider Level and/or the Retirement Plan Level by the system for eventual reporting to Plan Sponsor and/or Service Provider of missing answers. In one embodiment, dependent upon coding in the plan's audit set-up (i.e., as to who has access to information about audit completion progress, specific missing answers, related assigned responsibilities for completion, etc.) valid answers are saved 516 and tracked by the system for eventual reporting to Plan Sponsors and/or Service Providers.

If a problem is identified with an answer 517, the answer is flagged. In one embodiment, existence of operational, fiduciary, or compliance problems are determined via question attributes. In one embodiment, the degree of concern can be distinguished between “yellow-flagging” (warnings) and “red-flagging” (i.e., errors requiring highlighting and emphasis in system reports). Flagged answers are tracked by the system 518 for eventual reporting to Plan Sponsor and/or Service Provider, which can dependent upon user roles or permissions (i.e., as to who has access to information about potential design, operational, and/or compliance issues). Depending upon Plan Sponsor and/or Service Provider preferences (which can, in one embodiment, be associated with a questionnaire), reports and/or e-mail can be populated with details of the red/yellow-flagged responses for escalation and, where appropriate, corrected response.

Answers which are not red flagged are then presented to a reviewer 520 to which the reviewer responds. In one embodiment, respondents are required to enter their initials and date alongside every response to the questionnaire. Ultimately, every response is reviewed/approved by a specified, authorized plan representative (e.g. by the person defined in the question's “Best Person to Respond” attribute), with the reviewer similarly entering their initials and review date alongside the answer they are approving. Any reviewer concerns about the answer are treated by the system similarly to concerns raised by the system's editing features (see, e.g. steps 515 and 517), and routed to the next level of escalation as entered in program set-up, for example responses can be posted to secure message board for each authorized party and/or each party is notified by e-mail as to (i) the presence of information on their personal message (i.e., reporting) board, and (ii) any specifics about the nature of the information deemed appropriate in #4 above for communication in an e-mail. E-mailing can be consolidated for each recipient, so that multiple notifications are handled in a streamlined manner, through separate notifications by plan, regardless of volume.

The reviewer response is then saved 522 with the reviewers initials and the date of response as indicated above. If there are no outstanding problems with the answer, the answer is approved, representing the culmination of review and escalation processes described above, and is confirmed via completion of initialing/dating fields specific to the question and its answer.

The approved answers then appear in system reports. In one embodiment, the question attributes identify all interested parties to the response provided for each question—by role (i.e., level of escalation), by type of question (e.g., SAS 70-specific, SAS 115-specific, investment oriented, operationally-oriented, etc.) and by degree of concern (yellow/red flagged answers). Reports/message boards can also include metrics on questionnaire completion percentage and timing, relative to deadlines posted to the system in plan-specific program set-up. Access to reports can be password protected, with a master record of passwords only available to the Questionnaire Manager.

System reports can further include an online Summary Report that is available at all times, an online Progress Report available at all times, quantifying numbers of complete, incomplete, and “red flagged” answers, by section, and “Red Flag” Reports automatically e-mailed to designated staff distinguishing answers representing potential non-compliance by appropriate recipient (e.g., payroll director vs. recordkeeper vs. trustee), but positioning the recipient as responsible for distribution of reports to appropriate areas (i.e., no automated delivery to CEO, COO, CFO, etc. without specific entry into the system to that effect by the primary contact.)

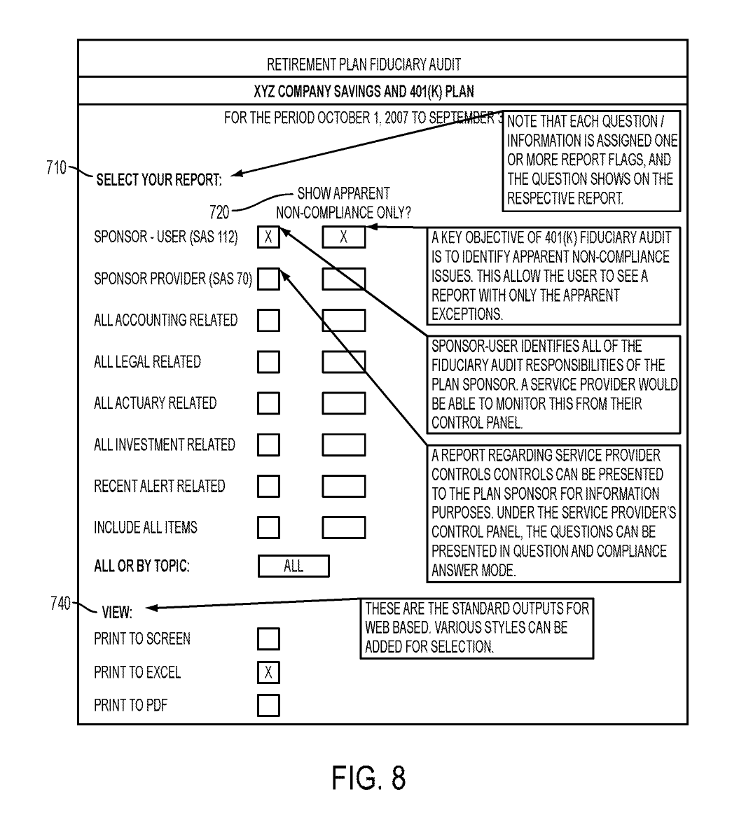

In one embodiment, System reports can be initiated by a report selection user interface provided by a Report Manager module such as that shown in FIG. 8. In the illustrated embodiment, the report selection interface allows a user to select one or more reports 710 by report flag (e.g. SAS 70), by user role (e.g. accounting, legal) or by topic. Reports may be selected such that only apparently non-compliant questions and answers are displayed. In one embodiment, reports may be produced in various physical formats 740. FIGS. 9A and 9B illustrate an exemplary report produced for SAS 115 related questions.

The System can additionally provide functionality such that E-mails are generated by the system to authorized recipients with respect to questionnaire completion status relative to deadline for completion (distinguished from audit/filing deadlines, again via preferences associated with the questionnaire.)

Question attributes can then be used to determine if the question will be reused 525. In one embodiment, modifications of question at the Master Level will override ‘re-use’ parameter. Application of modifications during questionnaire's completion period are controlled by Service Provider or other authorized user. If a question is not reused, it is deactivated 526. Questions can be deactivated at the Service Provider level and above, requiring authorized initials and dating for sign-off and online documentation of the rationale for the change (e.g., regulatory change, audit procedural change, etc.).

In one embodiment, the history of all deactivated questions, and of revisions to questions maintained by the system on a plan-by-plan basis, with annotation of reasons for each such revision, and the prerogative to reactivate the question upon authorized sign-off to do so.

When a user's session is complete, the user can then stop the session 527. In one embodiment, the user is alerted at the end of their session that log-off process will save all changes to the data entered for that plan. In one embodiment, log off can be a switch to another plan's questionnaire, with commensurate security/password procedures.

### Illustrative Examples of the Uses and Benefits Provided by the System

The Fiduciary Audit® System described above can, in some embodiments, be used to enhance fiduciary auditing functions as follows.

Retirement Plan Sponsors are subject to the SAS 115 reporting concerning internal controls. Internal control is a process—affected by those charged with governance or fiduciary responsibility, management, and other personnel—designed to provide reasonable assurance about the achievement of the entity's objectives with regard to reliability of (a) financial reporting, (b) effectiveness and efficiency of operations, and (c) compliance with applicable laws and regulations.

The 3 elements listed are inter-related and inter-dependent, typically involving different skill sets. Retirement Plan Sponsor fiduciaries are responsible for maintaining the internal control process to reduce the risks of errors to an acceptable level. The problem is that the coordination of requisite skill sets—the people resources with the technical backgrounds required to ensure compliance—is an arduous task for the retirement plan fiduciary.

The Fiduciary Audit® System disclosed herein maintains a people resource data set and provides for processes that assign specific questions to specific people based on standard organizational roles, client-specific personnel data, and the program's master library of questions (provided to the service provider for plan-specific refinement), and ultimately finalized for each plan to reasonably ensure optimum responses to all of the questions, with effectiveness and efficiency

Service Providers who administer retirement plans are often looked to by retirement plan fiduciaries for support in meeting their governance responsibilities, particularly concerning internal controls. This is because (i) Service Providers often administer many plans and typically assist the Retirement Plan Sponsor, with the initial set-up of the plan, and (ii) fiduciaries typically have limited knowledge of retirement plan internal controls given their involvement on a limited basis and other job responsibilities.

The Service Provider only has regular visibility of those internal controls relating to a retirement plan that reside within their operations. While the Service Provider's system of internal controls, which typically affect many retirement plans, is the subject of an annual SAS 70 attestation performed by an Independent Accountant/CPA, it does not cover internal controls at the Retirement Plan Sponsor level, the subject of SAS 115 reporting.

The Fiduciary Audit® System disclosed herein can, by design, process, and automated reporting oversight, enable the Service Provider to assist Retirement Plan Sponsor management and fiduciary responsibility with internal control compliance, with greater effectiveness and efficiency.

Relating to the above, the fiduciary and personnel at the Retirement Plan Sponsor are reliant on the Service Provider's SAS 70 report in conjunction with their governance responsibility. The internal controls subject to SAS 115 and SAS 70 are inter-dependent and inter-related. Together, they constitute the entire system of internal control. However, it is highly complex and arduous for a fiduciary to understand the relationship and effect they have on the risk for errors in plan administration, as the two sets of internal controls reside separately within the Retirement Plan Sponsor's and Service Provider's operations.

The Fiduciary Audit® System disclosed herein can provide the option of compiling and reporting the two operations' internal controls by way of a single unified process, with greater effectiveness and efficiency than presently exists in the retirement plan administration industry.

The Department of Labor mandates that Retirement Plans with over 100 participants be audited annually by an Independent Accountant/CPA. There is a general belief that this process, alone, provides the fiduciary with the necessary assurance of compliance. Three key factors relating to the Independent Accountant/CPA role as defined by the American Institute of Certified Public Accountants (AICPA) indicate that this general belief is not correct: (i) the auditor cannot be part of a client's internal control to avoid impairing the auditor's independence; (ii) the auditor's work is independent of the client's internal control over financial reporting, therefore, the auditor cannot be a compensating control for the client; and (iii) SAS 115 does not require the auditor to search for control deficiencies, but rather to evaluate them if they have been identified.

The reporting feature of the Fiduciary Audit® System disclosed herein provides the Independent Accountant/CPA with comprehensive information regarding financial reporting element of Internal Controls. The CPA only needs to evaluate non-compliance issues with audit-related implications, alerting the plan's legal counsel and service providers regarding operational and design concerns. With the ability to automatically populate role-specific reports with information relevant to the issue at hand, the resultant reports and communication from the Fiduciary Audit® process would have greater effectiveness and efficiency.

According to the AICPA, “the client's designation of an individual who possesses suitable skill, knowledge, and/or experience to oversee a service performed by the CPA (Ethics Interpretation 101-3 Performance of Nonattest Services) is not a control.” Thus current processes of assigning people to specific audit-related tasks is not sufficient to satisfy internal control.

The Fiduciary Audit® System disclosed herein can provide a cumulative, automated development of: questions, shaped into questionnaires, answered and reviewed by specifically designated staff aided by the program's help features, and reporting and communications with security and validation controls built into the process. In total, this program significantly increases the likelihood that the most appropriate resources are engaged throughout the audit process. This provides all fiduciaries and interested parties with reasonable assurance that the plan is in compliance with its stated, written objectives with regard to (i) the reliability of financial reporting, (ii) the effectiveness and efficiency of operations, and (iii) compliance with applicable laws and regulations, all with greater effectiveness and efficiency than presently exists in the retirement plan administration industry.

Management at an audit program development accounting firm (which may be, in some embodiments, a type of Master Control Organization) who are responsible for project management, coordination with programming and legal support and vendor utilization can use embodiments of the System to realize enhancement of the quality and effectiveness of existing questions within audit questionnaires and the program's options for dissemination of responses.

Technical staff at an audit program development accounting firm who are responsible for monitoring trade publications and regulatory developments, and are responsible for ongoing maintenance/enhancement to content and source documentation for audit questionnaires can use embodiments of the System to identify of patterns of DOL, AICPA, and/or GAAP non-compliance or material errors across multiple plans, thereby supporting the questionnaire's question development and review process.

A Plan Sponsor's accounting firm management, who is responsible for the plan's annual audit, preparation of IRS Form 5500, and financial statements, can use embodiments of the System for their annual preparation of the plan's financial statement, in accordance with DOL, AICPA, and GAAP requirements, and to identify any aspect of plan administration potentially constituting a material error, as defined by GAAP, requiring further investigation.

A plan's accounting firm technical staff that supports the plan's annual audit, preparation of Annual Financial Report Form 5500, etc. can use embodiments of the System to identify the appropriate plan transaction types that should be subject to sampling (i.e., confirmation letter mailing process) for the plan's annual audit and financial statement preparation.

Management at an audit program development law firm (which may be, in some embodiments, a type of Master Control Organization) which coordinates with accounting support and vendor utilization can use embodiments of the System to identify patterns of ERISA, DOL, IRS, and/or SEC potential non-compliance across multiple plans, (supporting the questionnaire's question development/review process).

Technical staff at a program development law firm, which monitors trade publications and regulatory developments, ongoing maintenance/enhancement to content and source documentation for questionnaire, can use embodiments of the System to maintain questions in the questionnaire, so they are worded properly to yield the most valuable responses for all of the purposes listed above and below (supporting the questionnaire's question development/review process).

The director of benefits/HR at a Retirement Plan Sponsor that confirms plan rules and intended operational procedures can use embodiments of the System to provide notification of appropriate follow-up required from each plan administrator and fiduciary (as represented by all of the claims above and below), based on the answers provided by the program's users.

The director of benefits/HR at a Retirement Plan Sponsor that confirms plan rules and intended operational procedures can use embodiments of the System to provide notification to appropriate senior management and specific fiduciaries of their need to view and respond to specific metrics regarding questionnaire completion and review progress.

The director of benefits/HR at a Retirement Plan Sponsor that confirms plan rules and intended operational procedures can use embodiments of the System for investigation/resolution of responses with implications on plan effectiveness (operationally and financially), department staffing, client-provider relationships, and legal and fiduciary compliance.

The chairman of an administrative committee of a plan sponsor that confirms procedures for hardship withdrawal and inbound rollover approval can use embodiments of the System for awareness of operational breakdowns and/or regulatory compliance and for refinement of procedures requiring committee involvement (e.g., hardship withdrawal approval, inbound rollover approval, etc.)

The director of payroll/HRIS systems of a Retirement Plan Sponsor that confirms data editing procedures and transmission can use embodiments of the System for proper payroll system calculations (e.g., plan compensation, employee and company contributions), proper updating of participants' and eligible employees' demographic information for all plan administration purposes, and proper systems interfaces to optimize the timing and accuracy of all data transmissions relevant to plan administration.

Internal legal counsel of a Retirement Plan Sponsor that confirms intended compliance monitoring rules and procedures, in conjunction with external counsel where applicable can use embodiments of the System for identification of any aspect of plan design or administration potentially out of compliance with the requirements of ERISA, the DOL, the IRS, and/or the SEC, requiring further investigation.

The chairman of the investment committee of a Retirement Plan Sponsor can use embodiments of the System for maintenance/enhancement of the plan's investments, their adherence to plan and policy statement requirements, and the fiduciary responsibilities associated with their selection and monitoring.

The chairman of the investment committee of a Retirement Plan Sponsor that confirms plan investment monitoring procedures, including the funding and investment of plan assets, in conjunction with investment consultant where applicable can use embodiments of the System for maintenance/enhancement of the plan's investments, their adherence to plan and policy statement requirements, and the fiduciary responsibilities associated with their selection and monitoring.

The director of employee communications at a Retirement Plan Sponsor that confirms the timing and content of information and notifications provided to plan participants can use embodiments of the System for maintenance/enhancement of legally required and other essential communications to plan participants and eligible employees—for consistency with plan rules, intended operational procedures, and across all mediums of communication (generic print, personalized print, automated voice response system, web site, live customer service, etc.)

The Chief Financial Officer/Treasurer of a Retirement Plan Sponsor that confirms the timing and content of all financial transactions for the plan can use embodiments of the System to be notified upon identification of significant operational, design, or compliance breakdown and can use embodiments of the System for resolution of responses with financial implications to the plan and/or the sponsoring company.

The Chief Operating Officer of a Retirement Plan Sponsor that is notified upon identification of significant operational, design, or compliance breakdown can use embodiments of the System for resolution of responses with implications on plan effectiveness (operationally and financially), internal staffing, client-provider relationships, and legal and fiduciary compliance.

The director of recordkeeping services of a Service Provider that confirms the consistency of the operation of plans with intended plan rules and procedures can use embodiments of the System resolution of audit responses with implications on the accuracy of participants' account information, transaction processing, information fed to plan communications, data provided to plan trustee, and metrics provided to plan sponsor.

The director of customer service of a Service Provider that confirms the timing and content of information and notifications provided to plan participants can use embodiments of the System for resolution of audit responses with implications on the accuracy of data and information provided to customer service representatives or by the representatives to participants and eligible employees.

The director of recordkeeping services of a Service Provider that confirms the consistency of the operation of plans with intended plan rules and procedures can use embodiments of the System for resolution of audit responses with implications on the accuracy of participants' account information, transaction processing, information fed to plan communications, data provided to plan trustee, and metrics provided to plan sponsor.

The director of trustee services of a Service Provider that confirms the accuracy of plan asset transactions, including related charges and expenses can use embodiments of the System for resolution of audit responses with implications on the accuracy of plan asset reporting, cash flow and investments, distributions, and related tax reporting.

The director of asset custodial services of a Service Provider that confirms the accuracy of plan asset transactions, including related charges and expenses can use embodiments of the System for resolution of audit responses with implications on the accuracy of plan asset reporting with respect to employer securities, their acquisition and liquidation, and related tax reporting.

The external legal counsel of a Retirement Plan Sponsor that confirms intended compliance monitoring rules and procedures, in conjunction with internal counsel where applicable can use embodiments of the System for identification of any aspect of plan design or administration potentially out of compliance with the requirements of ERISA, the DOL, the IRS, and/or the SEC, requiring further investigation.

A plan design/administration consultant employed by a Retirement Plan Sponsor can use embodiments of the System for resolution of audit responses with implications on the appropriateness of plan rules, the accuracy of the plan's recordkeeping and trust processes, the support provided by all interrelated systems (e.g., payroll, HRIS, checkwriting, nondiscrimination testing, etc.)

An investment consultant employed by a Retirement Plan Sponsor that confirms plan investment monitoring procedures, including the funding and investment of plan assets, in conjunction with investment committee chairman can use embodiments of the System to assist maintenance/enhancement of the plan's investments in coordination with the client's investment committee, their adherence to plan and policy statement requirements, and the fiduciary responsibilities associated with their selection and monitoring.

A chief actuary employed by a Retirement Plan Sponsor that confirms intended rules, procedures, and funding, and results of applicable compliance testing, in conjunction with a plan design/administration consultant can use embodiments of the System for resolution of responses with implications on the appropriateness of plan rules, the accuracy of the plan's funding and trust processes, related recordkeeping processes (where applicable), the support provided by all interrelated systems (e.g., payroll, HRIS, checkwriting, direct deposit, etc.)

Any fiduciary of a Retirement Plan Sponsor can use embodiments of the System for resolution of responses with implications on plan effectiveness (operationally and financially), and legal and fiduciary compliance.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

I claim:

1. A plan auditing system using a questionnaire, message board, and notification system to provide a plan sponsor with the ability to self-audit in a manner tailored to specific needs of the plan sponsor, and to report the results of such self-audit, the audit system comprising:
i. an identification module for auditing aspects of the plan via a questionnaire concerning the plan's design and administration to determine aspects that are potentially out of compliance with the requirements of at least one of ERISA, DOL, IRS and SEC standards,
ii. an investigation module providing:
a. notification of follow-up required from at least one plan administrator or fiduciary, based on the aspects that are potentially out of compliance;
b. notification to management and fiduciaries of a need to view and respond to specific metrics regarding at least one response to the questionnaire; and
c. deployment of an investigation of responses to the questionnaire, which responses have implications on at least one of: the plan's operational and financial effectiveness, department staffing, client-provider relationships, and legal and fiduciary compliance;
iii. a document update module to provide annual update to plan procedural documentation changes, the document update module providing
a. reporting on breakdowns in operational procedures and regulatory compliance; and
b. refinement of procedures requiring fiduciary involvement;
iv. a maintenance module for maintenance of the plan's investments, their adherence to plan and policy statement requirements, and the fiduciary responsibilities associated with their selection and monitoring, including:
a. a reparation system for reparation of responses to the questionnaire having implications on the accuracy of plan asset reporting, cash flow and investments, distributions, and related tax reporting;
b. a reparation system for reparation of responses to the questionnaire having implications on the accuracy of plan asset reporting with respect to employer securities, their acquisition and liquidation, and related tax reporting; and
c. an enhancement module for revision of the plan's investments in coordination with the client's investment committee, in accordance with adherence to plan and policy statement requirements, and the fiduciary responsibilities associated with their selection and monitoring;
v. a second maintenance module for maintenance of communications to plan participants and eligible employees for consistency with plan rules and intended operational procedures; and
vi. a compliance checker for demonstrating compliance with the plan audit requirement set forth in Statement on Auditing Standards (SAS) No. 115 (formerly 112) providing “reasonable assurance” about “the reliability of financial reporting, effectiveness and efficiency of operations, and compliance with applicable laws and regulations.”

2. A method for conducting a plurality of Fiduciary Audit® Operational Compliance Reviews comprising the steps:
receiving a template audit questionnaire, over a network, at a master control server from at least one master control user, wherein the template audit questionnaire comprises a plurality of audit topics, each audit topic comprising at least one audit question;
transmitting the audit questionnaire, over a network, to at least one service provider server,
whereby the at least service provider server is enabled to receive the audit questionnaire, over the network, thereby enabling the service provider server to create a plurality of customized audit questionnaires, using the at least one service provider server, wherein each customized audit questionnaire is created by modifying a copy of template audit questionnaire, thereby further enabling the at least service provider server to transmit each of the plurality of customized audit questionnaires, over the network, to at least one of a plurality of plan sponsor servers.

3. A system comprising:
at least one Service Provider server, wherein the at least one Service Provider server is configured to receive, over a network, a plurality of audit questions from at least one Master Program server, wherein each audit question comprises a plurality of question attributes, comprising at least a question text field, and an assignment to at least one audit questionnaire type,
wherein the at least one Service Provider server is further configured to create at least one Retirement Plan questionnaire for each of a plurality of Retirement Plans using at least some of the plurality of plurality audit questions;
wherein the at least one Service Provider server is further configured to enable at least one Retirement Plan user associated with each of the plurality of Retirement Plans to answer the audit questions on the at least one Retirement Plan questionnaire associated with the respective Retirement Plan.

4. The system of claim 3, wherein the at least one Service Provider server is further configured to receive audit question updates, over a network, for the of plurality audit questions from the at least one Master Program server.

5. The system of claim 4, wherein at least some of the audit question updates relate to changes from retirement industry technical update sources.

6. The system of claim 4 wherein the at least one Service Provider server is further configured to allow at least one Service Provider user to create audit question updates.

7. The system of claim 6, wherein the at least one Service Provider server is further configured to use the audit question updates to update audit questions in the at least one Retirement Plan questionnaire of each of the plurality of Retirement Plans.

8. The system of claim 2, wherein when at least some of the at least one Retirement Plan questionnaires are created, a Retirement Plan website is set up for each of the Retirement Plans associated with the respective Retirement Plan questionnaire such that the at least one Retirement Plan user associated with the respective Retirement Plan is enabled to answer questions on the respective Retirement Plan questionnaire using the respective Retirement Plan website.

9. The system of claim 6, wherein the at least one Service Provider server is further configured such that when at least some audit questions in at least one Retirement Plan questionnaire have been answered, a report containing data from the answered questions is generated.

10. The system of claim 9 wherein the report containing data from the answered questions is a SAS 70 report.

11. The system of claim 9 wherein the report containing data from the answered questions is a SAS 115 report.

12. The system of claim 3 wherein at least one audit question on at least one of the Retirement Plan questionnaires comprises an information attribute that comprises information that the at least one retirement user uses to answer the at least one audit question.

14. The system of claim 12, wherein the information attribute is an overall question complexity attribute.

15. The system of claim 12, wherein the information attribute is a business risk attribute.

16. The system of claim 12, wherein the information attribute is a recent regulatory alerts attribute.

17. The system of claim 12, wherein the information attribute is an attribute containing help text.

18. The system of claim 12, wherein the information attribute is an attribute containing a link to a data object.

19. The system of claim 12, wherein the information attribute is a suggested detailed compliance audit testing attribute.

20. The system of claim 3 wherein at least one audit question on at least one of the Retirement Plan questionnaires comprises a control attribute that controls the processing of the at least one audit question.

21. The system of claim 20, wherein the control attribute is a best person to answer the question attribute comprising at least one designated Retirement Plan user who has been designated to answer the at least one audit question,
wherein the at least one Service Provider server is further configured to initially display the at least one audit question to the at least one designated Retirement Plan user.

22. The system of claim 21, wherein the at least one designated Retirement Plan user can route the at least one audit question to a second Retirement Plan user.

23. The system of claim 20, wherein the control attribute is a best person to review the audit question comprising at least one designated Retirement Plan user who has been designated to review an answer to the at least one audit question,
wherein the at least one Service Provider server is further configured to display the at least one audit question and an answer to the at least one audit question to the at least one designated Retirement Plan user for review.

24. The system of claim 20, wherein the control attribute defines a method to capture an answer to the at least one audit question.

25. The system of claim 20, wherein the control attribute indicates a question should be answered by a Service Provider,
wherein the at least one Service Provider server is further configured to provide an answer to the question.

26. The system of claim 20, wherein the control attribute indicates an answer to the audit question should be rolled into a questionnaire for a future plan audit,
wherein the at least one Service Provider server is further configured to roll the answer into a questionnaire generated for a future plan audit.

27. A process comprising:
creating an audit question, using at least one computing device, wherein each audit question comprises a plurality of question attributes comprising at least a question text field;
importing and tracking, using the at least one computing device, retirement industry technical material, wherein the retirement industry technical material is imported, over a network, from at least one retirement industry technical material source;
a first user modifying at least one of the plurality of question attributes, using at least one computing device, based on the retirement industry technical material;
a second user reviewing and approving, using the at least one computing device, the modified question attributes;
logging the at least one question attribute modification, using the at least one computing device, wherein the at least one question attribute modification, the first user, the second user, and the retirement industry technical material the modification was based on is logged.

28. The process of claim 27, wherein the plurality of question attributes further comprises at least one attribute for containing information for assisting users in reviewing and answering the audit question.

29. The process of claim 28, wherein the at least one attribute is an overall question complexity attribute.

30. The process of claim 28, wherein the at least one attribute is a business risk attribute.

31. The process of claim 28, wherein the at least one attribute is a recent regulatory alerts attribute.

32. The process of claim 28, wherein the at least one attribute is a best person to answer the question attribute.

33. The process of claim 28, wherein the at least one attribute is an attribute containing help text.

34. The process of claim 28, wherein the at least one attribute is an attribute containing a link to a data object.

35. The process of claim 28, wherein the at least one attribute is a best person to review the audit question.

36. The process of claim 28, wherein the at least one attribute is an attribute containing help text relating to non-compliance.

37. The process of claim 28, wherein the at least one attribute is a suggested detailed compliance audit testing attribute.

38. The process of claim 28, wherein the at least one attribute is a best person to review the audit question attribute.

39. The process of claim 28, wherein the at least one attribute defines a method to capture an answer to the audit question.

40. The process of claim 28, wherein the at least one attribute defines a topic for sorting the audit question on a report.

41. The process of claim 28, wherein the at least one attribute that defines a Service Provider level or Retirement Plan level internal control relationship.

42. The process of claim 28, wherein the at least one attribute that indicates the audit question was superseded.

43. The process of claim 28, wherein the at least one attribute indicates a question should be answered by a Service Provider.

44. The process of claim 28, wherein the at least one attribute indicates a level at which the audit question was modified.

45. The process of claim 28, wherein the at least one attribute indicates if and how an answer to the audit question should be rolled into a questionnaire for a future plan audit.

46. A system comprising:
a master question database having a structure adapted to receive a plurality of questions and to maintain a relationship between the questions;
an interface adapted to permit a user to populate the master question database with a plurality of questions;
the interface further adapted to permit the user to create associations between the questions, the associations describing the relationship between the questions;
operatively transmitting the master question database to a Service Provider server;
creating, at the Service Provider server, a first questionnaire from a subset of the questions in the transmitted master question database, the first questionnaire including a first question;
editing the first question in the master question database to form an edited first question;
transmitting the edited first question to the Service Provider server and instructing the Service Provider server to replace the first question with the edited first question;
replacing, at the Service Provider server, the first question with the edited first question; and
creating, at the Service Provider server, a second questionnaire from a subset of the questions in the master question database, the second questionnaire including the edited first question.
